(19) United States
(12) Patent Application Publication
(10) Pub. No.: US 2009/0025810 A1
(43) Pub. Date: Jan. 29, 2009

(54) MICRO-VORTEX GENERATOR

(76) Inventors: Andrew M. Wo, Taipei (TW); Cheng-Ming Lin, Taipei (TW); Yu-Shiang Lai, Taipei (TW)

Correspondence Address: RABIN & Berdo, PC, 1101 14TH STREET, NW, SUITE 500, WASHINGTON, DC, 20005, US

(21) Appl. No.: 11/867,163

(22) Filed: Oct. 4, 2007

(30) Foreign Application Priority Data
Jul. 27, 2007 (TW) 096127549

(51) Int. Cl. F15C 3/00

(52) U.S. Cl. 137/808

(57) ABSTRACT

The present invention relates to a MEMS-based micro-oscillator which can generate specific vortical pattern in a micro-channel. The micro-vortex generator is composed of a suspended bridge with a gold-plated, rectangular flat-plate as the primary structure. When an AC current passed through the gold leads under an external magnetic field, the plate will oscillate due to Lorenz force, thereby generating micro-vortices.

### FIELD OF THE INVENTION

The present invention relates to a vortex generator, and more particularly, to a micro-vortex generator adopted in microfluidic devices for bio-chemical applications.

### BACKGROUND OF THE INVENTION

Recently, Micro-Electro-Mechanical Systems (MEMS) and bio-technologies has been developing rapidly. Micro-vortex can be utilized to accelerate bio-chemical analysis and reduce required biological samples and reagents. Besides, the micro-vortex is combined with micro-array platform to obtain parallel high-throughput experimental results.

U.S. Pat. No. 6,170,981 B1 published on Jan. 9, 2001, titled “In Situ Micromachined Mixer for microfluidic analytical systems” disclosed to generate micro-vortices through electroosmotic flow (EOF) in a micromachined mixer, and the generated micro-vortices are utilized to enhance the fluid mixing efficiency in multiple intersecting channels.

Additionally, U.S. Pat. No. 6,787,018 B1 published on Sep. 7, 2004, titled “Dielectrophoretic concentration of particles under electrokinetic flow” disclosed a method and apparatus for collecting particles in a microfluidic channel using the combination of dielectrophoresis (DEP) and electrokinetic/electroosmotic flow.

However, the apparatuses of the mentioned patents can only be used under applied potential across the flow channel causing ion migration (U.S. Pat. No. 6,170,981 B1) and under restricted conditions based on dielectric properties of particle/medium combination (U.S. Pat. No. 6,787,018 B1). To overcome these shortcomings and increase the value of a micro-vortex device, it is essential to develop a miniaturized device which provides mechanical actuation of micro-vortices, which can perform multiple functions in various applications, for example in bio-technology discipline.

### SUMMARY OF THE INVENTION

The primary objective of the present invention is to provide a micro-vortex generator. The micro-vortex generator comprises a suspended bridge a magnetic field source, wherein the suspended bridge further includes a plate and an electrode, and the electrode is disposed on the plate to supply AC current to the suspended bridge. In addition, the electrode is an inert metal, such as Au, used to avoid the shortcoming of easy-oxidation of high-conductivity materials. Subsequently, the electrode further includes a protective layer to protect the electrode from liquid, and the protective layer is made of Teflon or SiO₂. Besides, the magnetic field source is a magnet or a magnetic thin film disposed with the magnetic field lines at an angle to the suspended bridge. Based on Lorenz force law, a force is provided to make the plate of suspended bridge oscillate to generate micro-vortices when the suspended bridge and the electrode passed through by the magnetic field and an AC current respectively.

Moreover, the micro-vortex generator is oscillated to actively generate micro-vortices. Accordingly, it is not necessary for the micro-vortex generator to operate under large Reynolds number. Furthermore, the size of micro-vortex depends on the oscillation frequency of suspended bridge, with the oscillation frequency of suspended bridge controlled through the geometry of the suspended bridge. Besides, the micro-vortex generator could be used as a mixer to provide higher mixing efficiency or applied in a bio-sensor to promote bio-molecule binding efficiency. The micro-vortex generator could also be utilized to trap and culture cells. Additionally, the micro-vortex generator could be adopted to shorten the reaction time of bio-molecule identification and cell separation.

The second objective of the present invention is to provide another micro-vortex generator. The micro-vortex generator comprises a suspended bridge and a static electric field source, wherein the suspended bridge further includes a plate and an electrode, and the electrode is an inert metal and disposed on the plate to supply AC current to the suspended bridge. In addition, the static electric field source is an electrode and disposed at the side of the suspended bridge. As the suspended bridge and the static electric field source are electrified respectively, a potential difference is produced therebetween to make the suspended bridge oscillate to generate micro-vortices.

Moreover, the suspended bridge is a thin film material, which is made of Si₃N₄, a high strength carbonized material, SiO₂ or polymer.

### BRIEF DESCRIPTIONS OF THE DRAWINGS

The foregoing aspects, as well as many of the attendant advantages and features of this invention will become more apparent by reference to the following detailed description, when taken in conjunction with the accompanying drawings, wherein:

FIG. 1 illustrates the first embodiment of the present invention;

FIG. 2 illustrates the first embodiment when used;

FIG. 3A illustrates the substrate;

FIG. 3B illustrates the Si₃N₄ layer deposited on the substrate;

FIG. 3C illustrates the thin metal layer of Cr and Au deposited on the Si₃N₄ layer;

FIG. 3D illustrates the positive photo-resist coated on the thin metal layer of Cr and Au;

FIG. 3E illustrates the etching of the thin metal layer of Cr and Au without positive photo-resist coated;

FIG. 3F illustrates another positive photo-resist coated on the suspended bridge substrate;

FIG. 3G illustrates the positive photo-resist after developed;

FIG. 3H illustrates the etching of the Si₃N₄ layer without positive photo-resist coated;

FIG. 3I illustrates the removing of positive photo-resist;

FIG. 3J illustrates the etching of the substrate;

FIG. 4 illustrates the first embodiment integrated in a chip; and

FIG. 5 illustrates the second embodiment of the present invention.

### DETAILED DESCRIPTIONS OF THE PREFERRED EMBODIMENT

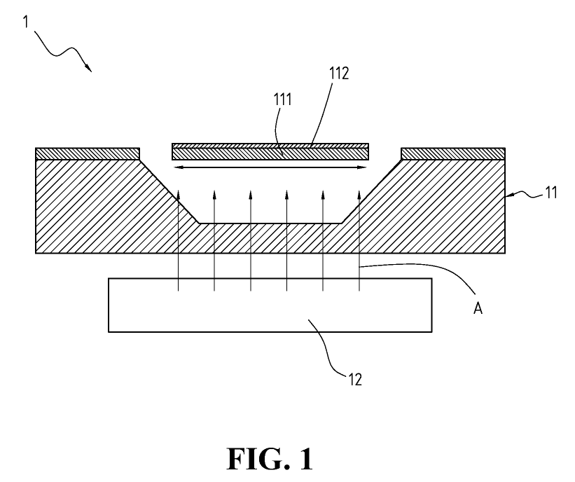

Referring to FIG. 1 to illustrate the first embodiment of the present invention, a micro-vortex generator 1 is provided and adopted in bio-mechatronics field. The micro-vortex generator 1 comprises a suspended bridge 11 and a magnetic field source 12, wherein the suspended bridge 11 further includes a plate 111 and an electrode 112, and the electrode 112 is disposed on the plate 111 to supply AC current to the suspended bridge 11. In addition, the electrode 112 is an inert metal, such as Au, used to avoid the shortcoming of easy-oxidation of high-conductivity materials. Subsequently, the electrode 112 further includes a protective layer (unshown) to protect the electrode 112 from liquid, and the protective layer is made of Teflon or SiO₂. Besides, the magnetic field source 12 is a magnet or a magnetic thin film disposed with the magnetic field lines at an angle to the suspended bridge 11.

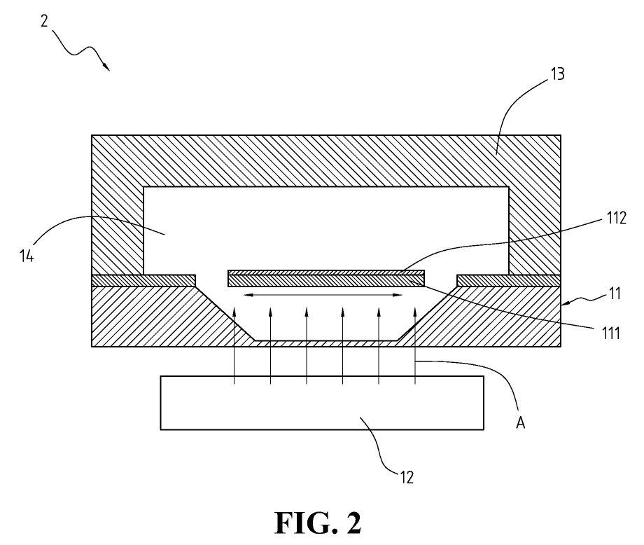

Furthermore, with reference to FIG. 2 illustrating the first embodiment when used, wherein a fluidic channel 13 is set on the micro-vortex generator 2, and a fluid 14 is disposed between the fluidic channel 13 and the suspended bridge 11. Based on Lorenz Force Law, a force is provided to make the plate 111 of suspended bridge 11 oscillate to generate micro-vortices when the suspended bridge 11 and the electrode 112 passed through by a magnetic field A and an AC current respectively. Consequently, it is not necessary for the micro-vortex generator 2 to be drived under large Reynolds number. Therefore, the micro-vortex generator 2 could be an automatic vortex generator. Moreover, the micro-vortex generator 2 could be used as a mixer to provide higher mixing efficiency or applied in a bio-sensor to gain higher bio-molecule binding efficiency. The micro-vortex generator 2 could also be utilized to trap and culture cells, when smaller vortices generated.

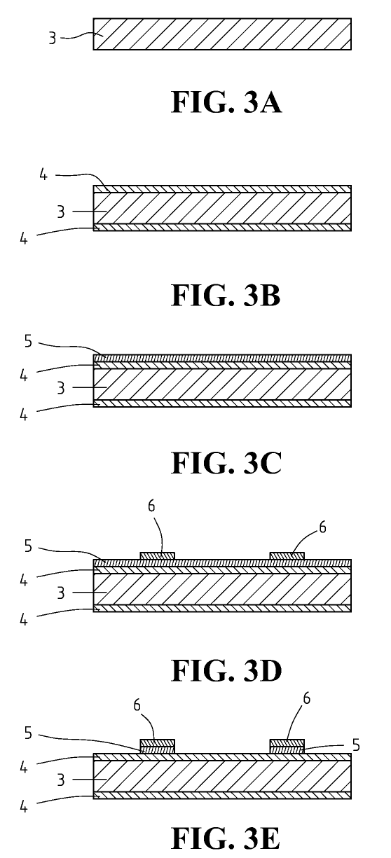

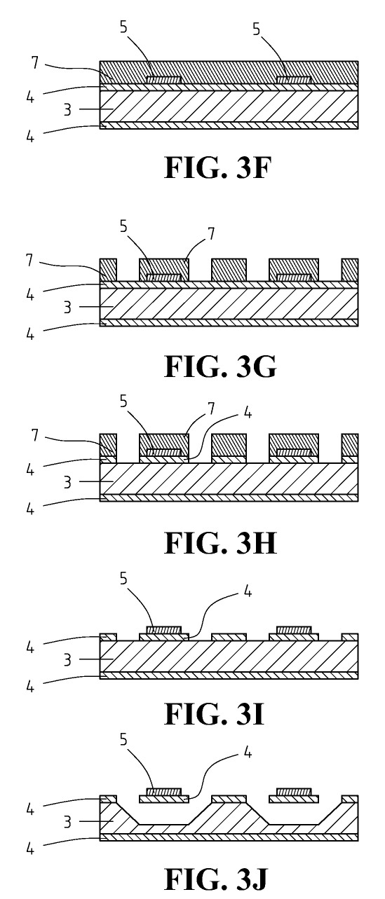

Additionally, the micro-vortex generator is made by the miniaturization technology of Micro-Electro-Mechanical-Systems (MEMS). With reference to FIG. 3A˜3J illustrating the manufacturing process of the suspended bridge. The suspended bridge is made of a thin film material, which is made of Si₃N₄, a high strength carbonized material, SiO₂ or polymer. FIG. 3A illustrates the substrate, wherein a chip is used as the substrate 3 of the suspended bridge 11. As illustrated in FIG. 3B, a Si₃N₄ layer 4 is deposited on the substrate 3 by the Low Pressure Chemical Vapor Deposition System (LPCVD System). Subsequently, referring to FIG. 3C, the thin metal layer 5 of Cr and Au is deposited on the Si₃N₄ layer 4 by electron beam evaporation, and the thin metal layer 5 is adopted as the electrode to provide AC current. Moreover, as illustrated in FIG. 3D, a positive photo-resist 6 (s1813) is coated on the thin metal layer 5 of Cr and Au by a spin coater to define the size of the plate of the suspended bridge. Then, referring to FIG. 3E, the substrate 3 coated with the positive photo-resist 6 is immersed in Au etchant and Cr etchant orderly to remove the thin metal layer 5 which is not coated by the positive photo-resist 6, and acetone is utilized to remove the positive photo-resist 6 on the surface of substrate 3 to clarify the size of the plate.

Subsequently, FIG. 3F illustrates another positive photo-resist 7 coated on the surface of substrate 3 to make the plate suspended, and as illustrated in FIG. 3G, the positive photo-resist 7 is developed by developer (MF319) to define the area where dry etching is performed. Besides, as illustrated in FIG. 3H, the areas of Si₃N₄ layer 4, which are not coated with the positive photo-resist 7, are removed through dry-etching by reactive ion etching (RIE), and FIG. 3I illustrates the positive photo-resist 7 on the substrate 3 removed by acetone. Finally, with reference to FIG. 3J, the substrate 3 is disposed in KOH etchant, then the substrate 3 is etched along lattice of the chip to obtain a suspended bridge, and the suspended bridge could be coupled with a magnetic field source to form the micro-vortex generator of the first embodiment.

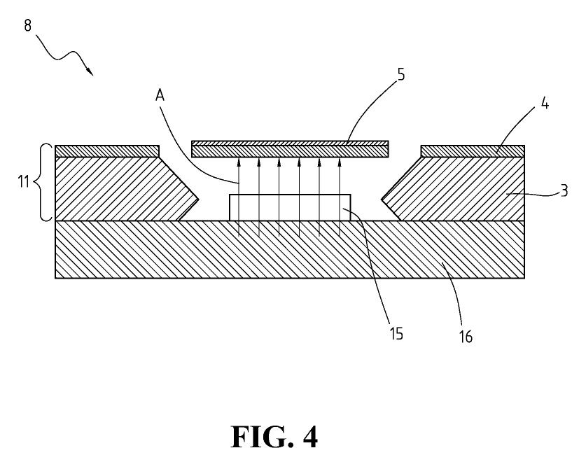

Furthermore, the micro-vortex generator of the first embodiment could be integrated in a chip to comply with the demand of miniaturization. With reference to FIG. 4 illustrating the first embodiment integrated in a chip, wherein the chip with a suspended bridge 11 is etched by two sides etching in the manufacturing process, then the Si₃N₄ layer 4 at the bottom of the suspended bridge 11 is removed. Then KOH wet etching is performed and an opening is formed at the bottom of the suspended bridge 11. Subsequently, a magnetic material 15 is deposited on another substrate 16. The substrate 16 with the magnetic material 15 and the suspended bridge 11 which has an opening at the bottom are combined together. Consequently, the micro-vortex generator 8 which is integrated in a chip is completed.

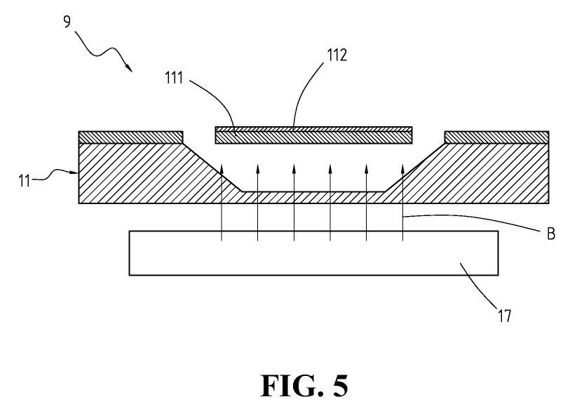

In addition, the magnetic field source of the micro-vortex generator could be replaced by a static electric field source. Referring to FIG. 5 illustrating the second embodiment of the present invention, wherein the micro-vortex generator 9 comprises a suspended bridge 11 and a static electric field source 17, and the suspended bridge 11 further includes a plate 111 and an electrode 112. The electrode 112 is disposed on the plate 111 to supply AC current to the suspended bridge 11. Moreover, the static electric field source 17 is an electrode and disposed at the side of the suspended bridge 11. As the suspended bridge 11 and the static electric field source 17 are electrified, a potential difference is produced therebetween. The potential difference will produce a static electric force B to make the suspended bridge 11 oscillate to generate micro-vortices.

While the invention has been particularly shown and described with reference to the preferred embodiments thereof, these are merely examples to help clarify the invention and are not intended to limit the invention. It will be understood by those skilled in the art that various changes, modifications, and alterations in form and details may be made therein without departing from the spirit and scope of the invention, as set forth in the following claims.

What is claimed is:

1. A micro-vortex generator, comprising:
a suspended bridge; and
a magnetic field source;
wherein the magnetic field source providing a force to make the suspended bridge oscillate, thereby generating micro-vortices.

2. The micro-vortex generator of claim 1, wherein the magnetic field source is disposed with magnetic field lines at an angle to the suspended bridge.

3. The micro-vortex generator of claim 1, wherein the magnetic field source is a magnet or a magnetic thin film.

4. The micro-vortex generator of claim 1, wherein the suspended bridge further includes a plate and an electrode, and the electrode is disposed on the plate to supply AC current to the suspended bridge.

5. The micro-vortex generator of claim 1, wherein the suspended bridge is a thin film material.

6. The micro-vortex generator of claim 4, wherein the electrode further includes a protective layer to protect the electrode from liquid, the protective layer is made of Teflon or SiO₂.

7. The micro-vortex generator of claim 4, wherein the electrode is an inert metal, and the inert metal is Au.

8. The micro-vortex generator of claim 5, wherein the thin film material is made of Si₃N₄, a high strength carbonized material, SiO₂ or polymer.

9. A micro-vortex generator, comprising:
a suspended bridge; and
a static electric field source, disposed at the side of the suspended bridge;
whereby a potential difference formed between the suspended bridge and static electric field source providing a force to make the suspended bridge oscillate, thereby generating micro-vortices.

10. The micro-vortex generator of claim 9, wherein the static electric field source is an electrode utilized to supply AC current.

11. The micro-vortex generator of claim 9, wherein the suspended bridge further includes a plate and an electrode, and the electrode is disposed on the plate to supply AC current to the suspended bridge.

12. The micro-vortex generator of claim 9, wherein the suspended bridge is a thin film material.

13. The micro-vortex generator of claim 11, wherein the electrode further includes a protective layer to protect the electrode from liquid, and the protective layer is made of Teflon or SiO₂.

14. The micro-vortex generator of claim 11, wherein the electrode is an inert metal, and the inert metal is Au.

15. The micro-vortex generator of claim 12, wherein the thin film material is made of Si₃N₄, a high strength carbonized material, SiO₂ or polymer.
